(19) United States
(12) Patent Application Publication
(10) Pub. No.: US 2018/0014175 A1
(43) Pub. Date: Jan. 11, 2018

(54) ENHANCED SYSTEM INFORMATION BLOCK READING MECHANISMS TO IMPROVE SYSTEM SELECTION FUNCTIONALITY

(71) Applicant: QUALCOMM Incorporated, San Diego, CA (US)

(72) Inventors: Preyas DESAI, San Diego, CA (US); Yongsheng SHI, San Diego, CA (US); Neeleshwar IYER, San Diego, CA (US); Satish Pavan Kumar NICHANAMETLA, Secunderbad (IN); Sitaramanjaneyulu KANAMARLAPUDI, San Diego, CA (US)

(21) Appl. No.: 15/205,971

(22) Filed: Jul. 8, 2016

(51) Int. Cl. H04W 8/02; H04W 84/04

(52) U.S. Cl. CPC H04W 8/02; H04W 84/042

(57) ABSTRACT

A method for reading system information blocks (SIBs) by a mobile communication device includes: reading information from a first master information block (MIB); reading information from one or more SIBs including SIB3; storing the information read from the first MIB and the one or more SIBs including SIB3; starting a validity timer; reading information from a second MIB; comparing the information read from the second MIB with the stored information from the first MIB; in response to determining that the information read from the second MIB matches the stored information from the first MIB, determining whether the validity timer has expired; and in response to determining that the validity timer has not expired, determining that the stored information read from the first MIB and the one or more SIBs including SIB3 is valid.

### BACKGROUND

In wideband code division multiple access (WCDMA) systems, system information block (SIB) 3 contains cell suitability information, for example, but not limited to, cell barring, cell identification (ID)/closed subscriber group (CSG) cell ID, minimum quality level (Qualmin), minimum received level (Rxlevmin). SIB3 should be read by the mobile communication device to obtain information for background public land mobile network (BPLMN) search, cell selection, out-of-service (OOS) scans, etc., even if the master information block (MIB) value tag has not changed.

Repeated SIB3 reading may result in delayed BPLMN search, cell selection, and OOS scans. During BPLMN search, repeated SIB3 reading may cause the mobile communication device to miss pages on the serving cell when the SIB3 repetition rate is greater than the paging discontinuous receive (DRX) cycle. Further, unnecessary power consumption may result, especially for BPLMN search where multiple cells need to be read.

Repeated SIB3 reading may also impact the performance in subscriber identity module (SIM) devices, where reading SIBs on one subscription may compete for radio frequency (RF) and baseband resources with another subscription. For example, when one subscription is in a packet switched (PS) call, unnecessarily SIB3 reading may cause frequent tune-away to another subscription. Throughput on the PS call may be seriously degraded.

Further, continually deferring procedures (e.g., OOS, BPLMN, and cell selection) to avoid using incorrect SIB3 data may increase delay for the procedures.

### SUMMARY

Apparatuses and methods for reading system information blocks are provided.

According to various aspects there is provided a method for reading system information blocks (SIBs) by a mobile communication device. In some aspects, the method may include: reading information from a first master information block (MIB); reading information from one or more SIBs including SIB3; storing the information read from the first MIB and the one or more SIBs including SIB3; starting a validity timer; reading information from a second MIB; comparing the information read from the second MIB with the stored information from the first MIB; in response to determining that the information read from the second MIB matches the stored information from the first MIB, determining whether the validity timer has expired; and in response to determining that the validity timer has not expired, determining that the stored information read from the first MIB and the one or more SIBs including SIB3 is valid.

According to various aspects there is provided a mobile communication device. In some aspects, the mobile communication device may include: a communication unit configured to communicate with one or more communication networks; a memory operably connected to the communication unit; a timing unit configured to implement one or more timers; and a control unit operably connected to the communication unit, the memory, and the timing unit.

The control unit configured to: control the communication unit to read information from a first master information block (MIB); control the communication unit to read information from one or more SIBs including SIB3; control the memory to store the information read from the first MIB and the one or more SIBs including SIB3; control the timing unit to start a validity timer; control the communication unit to read information from a second MIB; compare the information read from the second MIB with the stored information from the first MIB; in response to determining that the information read from the second MIB matches the stored information from the first MIB, determine whether the validity timer has expired; and in response to determining that the validity timer has not expired, determine that the stored information read from the first MIB and the one or more SIBs including SIB3 is valid.

According to various aspects there is provided a non-transitory computer readable medium. In some aspects, the non-transitory computer readable medium may include instructions for causing one or more processors of a mobile communication device to perform operations including: reading information from a first master information block (MIB); reading information from one or more SIBs including SIB3; storing the information read from the first MIB and the one or more SIBs including SIB3; starting a validity timer; reading information from a second MIB; comparing the information read from the second MIB with the stored information from the first MIB; in response to determining that the information read from the second MIB matches the stored information from the first MIB, determining whether the validity timer has expired; and in response to determining that the validity timer has not expired, determining that the stored information read from the first MIB and the one or more SIBs including SIB3 is valid.

According to various aspects there is provided a mobile communication device. In some aspects, the mobile communication device may include: means for reading information from a first master information block (MIB); means for reading information from one or more SIBs including SIB3; means for storing the information read from the first MIB and the one or more SIBs including SIB3; means for starting a validity timer; means for reading information from a second MIB; means for comparing the information read from the second MIB with the stored information from the first MIB; in response to determining that the information read from the second MIB matches the stored information from the first MIB, means for determining whether the validity timer has expired; and in response to determining that the validity timer has not expired, means for determining that the stored information read from the first MIB and the one or more SIBs including SIB3 is valid.

Other features and advantages should be apparent from the following description which illustrates by way of example aspects of the various teachings of the disclosure.

### BRIEF DESCRIPTION OF THE DRAWINGS

Aspects and features of the various examples will be more apparent by describing examples with reference to the accompanying drawings, in which:

FIG. 1A is a block diagram illustrating a mobile communication device according to various examples;

FIG. 1B is a diagram illustrating a network environment for various examples; and

FIG. 2 is a flowchart illustrating a method for reading system information blocks according to various examples.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

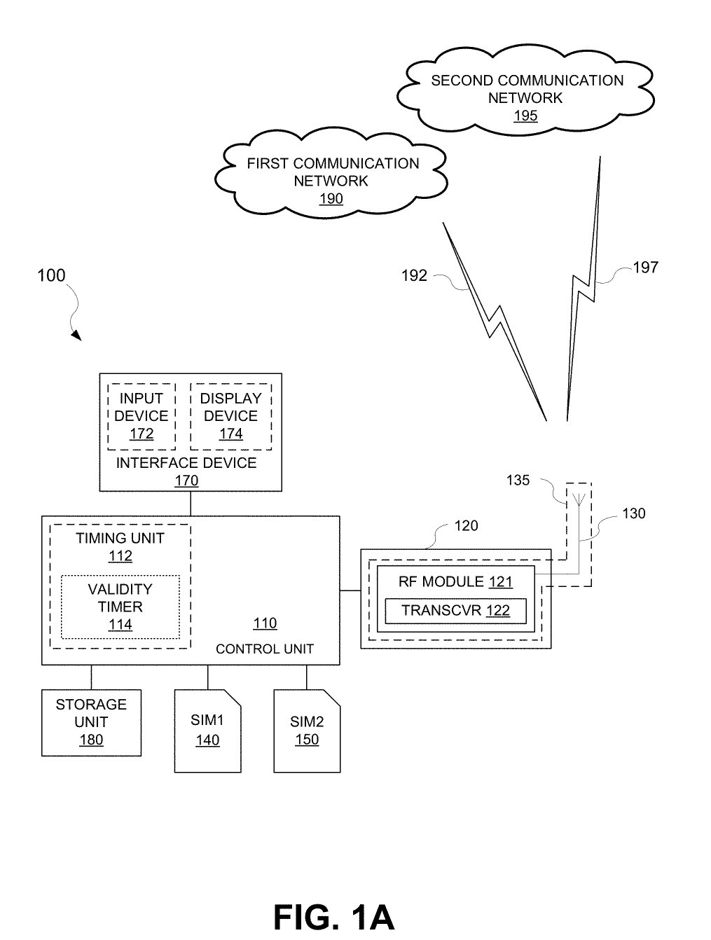

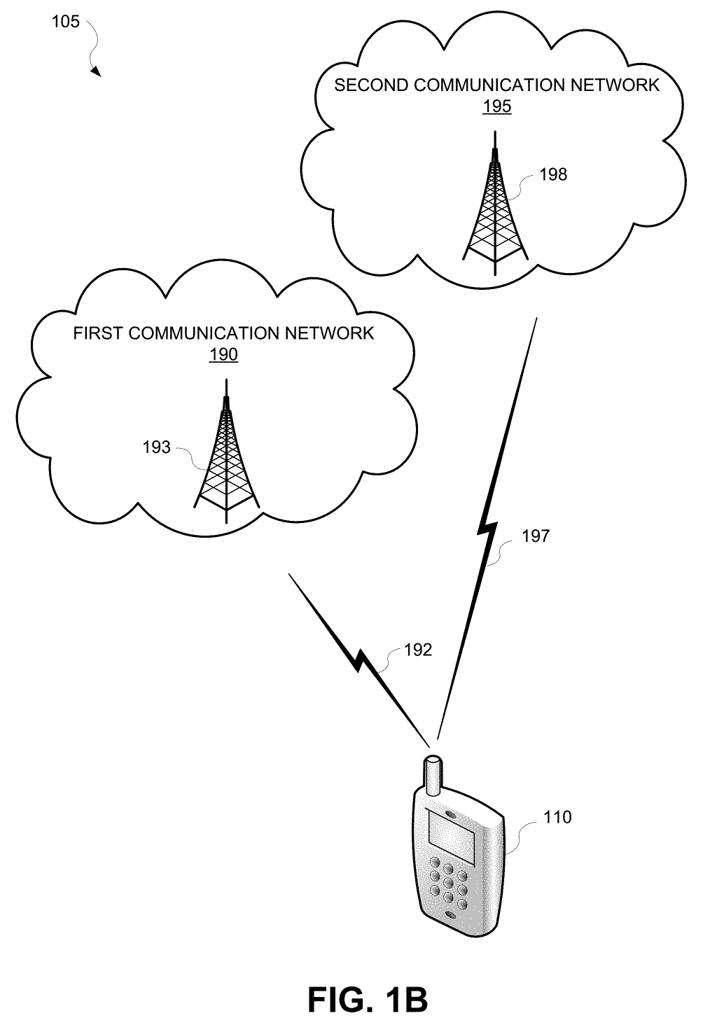

FIG. 1A is a block diagram illustrating a mobile communication device 100 according to various examples. As illustrated in FIG. 1A, the mobile communication device 100 may include a control unit 110, a communication unit 120, an antenna 130, a first subscriber identity module (SIM) 140, a second SIM 150, a user interface device 170, and a memory 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communication units) and may interface with one or more antennas without departing from the scope of protection.

The communication unit 120 may include, for example, but not limited to, an RF module 121. The RF module 121 may include, for example, but not limited to the first transceiver 122. An RF chain 135 may include, for example, but not limited to the antenna 130 and the RF module 121.

One of ordinary skill in the art will appreciate that examples of the mobile communication device 100 may include more than one communication unit and/or more than one antenna without departing from the scope of protection.

A SIM (for example the first SIM 140 and/or the second SIM 150) in various examples may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various examples may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the communication unit 120 with a first subscription (Sub1) 192 associated with a first radio access technology (RAT) on a first communication network 190 and the second SIM 150 may associate the communication unit 120 with a second subscription (Sub2) 197 associated with a second RAT on a second communication network 195. When a RAT is active, the communication unit 120 receives and transmits signals on the active RAT. When a RAT is idle, the communication unit 120 receives but does not transmit signals on the idle RAT.

For convenience, the various examples are described in terms of dualism SIM dual-standby (DSDS) mobile communication devices. However, one of ordinary skill in the art will appreciate that the various examples may be extended to Multi-SIM Multi-Standby (MSMS) and/or Multi-SIM Multi-Active (MSMA) and/or single-SIM mobile communication devices without departing from the scope of protection.

The first communication network 190 and the second communication network 195 may be operated by the same or different service providers, and/or may support the same or different RATs, for example, but not limited to, GSM, CDMA, WCDMA, and long term evolution (LTE).

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various examples.

The control unit 110 may be configured to control overall operation of the mobile communication device 100 including control of the communication unit 120, the user interface device 170, and the memory 180. The control unit 110 may be a programmable device, for example, but not limited to, a microprocessor (e.g., general-purpose processor, baseband modem processor, etc.) or microcontroller.

The control unit 110 may include a timing unit 112 configured to implement one or more timers, for example, but not limited to, one or more validity timers 114. Alternatively, the timing unit 112 may be implemented as electronic circuitry separate from the control unit 110.

The memory 180 may be configured to store operating systems and/or application programs for operation of the mobile communication device 100 that are executed by the control unit 110, as well as to store application data and user data.

FIG. 1B is a diagram illustrating a network environment 105 for various examples. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of protection.

The first communication network 190 and the second communication network 195 may implement the same or different radio access technologies (RATs). For example, the first communication network 190 may be a GSM network and the first subscription 192 may be a GSM subscription. The second communication network 195 may also be a GSM network. Alternatively, the second communication network 195 may implement another RAT including, for example, but not limited to, LTE, WCDMA, and Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various examples.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

SIB3 contains information used by the mobile communication device 100 for BPLMN search, cell selection, and OOS scans and is typically read even if the MIB value tag has not changed indicating that no changes have occurred in the SIB3 information. The mobile communication device 100 may store the SIB information, including the SIB3 information, in a SIB database. For example, the SIB information may be stored in a SIB database residing in the memory 180 or other internal storage of the mobile communication device 100. A SIB timer may clear the SIB database about every six hours so that all SIB information will be re-read by the mobile communication device 100.

In various examples, the mobile communication device 100 may read information from a first MIB as well as SIB information from a plurality of SIBs including SIB3 and may store the information in the SIB database, for example in the memory 180. Upon performing an operation, for example, but not limited to, BPLMN search, cell selection/reselection, OOS scan, etc., the mobile communication device 100 may read information from a second MIB to determine the MIB value tag and the public land mobile network (PLMN) ID.

The mobile communication device 100 may compare various pieces of information, for example, but not limited to, the MIB value tag, PLMN ID, cell frequency, PSC, and MIB bit string, with the stored information from the first MIB to determine if the cell was previously camped-on by the mobile communication device 100. If the information from the MIB being read matches the stored MIB information then the SIB3 information may be valid and the mobile communication device 100 may not read the SIB3 information again.

In at least one case, however, the information from the MIB being read may match the stored MIB information but the SIB3 information may not be valid. Mobile communication network operators may deploy cells that are geographically spaced, for example, in different cities, that use the same MIB information. Accordingly, the MIB information (e.g., the MIB value tag, PLMN ID, cell frequency, PSC, and MIB bit string) may be the same for both geographically spaced cells. With the deployment of small cells in combination with high-speed travel (e.g., by train or automobile) in a high mobility mode a mobile communication device 100 may travel through two different cells having the same MIB information before the SIB timer expires causing the mobile communication device 100 to re-read the SIB information including the SIB3 information.

In various examples, a validity timer (e.g., the validity timer 114) may be provided. The duration of the validity timer 114 may be variable based on a mobility mode of the mobile communication device 100. The validity timer 114 may have a duration T where T equals T1 if the mobile communication device 100 is not in a high mobility mode and T equals T2 if the mobile communication device 100 is in a high mobility mode, where T1 is greater than T2.

For example, when the mobile communication device 100 performs five or more serving cell changes using cell selection or reselection within 10 minutes, the mobile communication device 100 may be considered to be in high mobility mode and the control unit 110 may control the timing unit 112 to set a duration of about 15 minutes for the validity timer 114.

On the other hand, if the mobile communication device 100 is not in a high mobility mode, for example, the mobile communication device 100 makes less than five serving cell changes using cell selection or reselection within 10 minutes or the mobile communication device 100 is substantially stationary, the control unit 110 may control the timing unit 112 to set a duration of greater than about 15 minutes for the validity timer 114. The duration of the validity timer 114 may be changed if the mobile communication device 100 changes mobility modes (e.g., from high mobility mode to not high mobility mode or vice versa).

Thus, if the validity timer 114 has expired, even if the information read from a MIB matches the stored MIB information, the mobile communication device will re-read SIB information including SIB3 information. One of ordinary skill in the art will appreciate that the various examples are applicable to SIBs other than SIB3 and to various radio access technologies without departing from the scope of the protection.

One of ordinary skill in the art will appreciate that other mobility characteristics may additionally or alternatively be considered and the durations set for the validity timer may be longer or shorter without departing from the scope of the examples. Further, one of ordinary skill in the art will appreciate that additional mobility modes may be employed without departing from the scope of the examples.

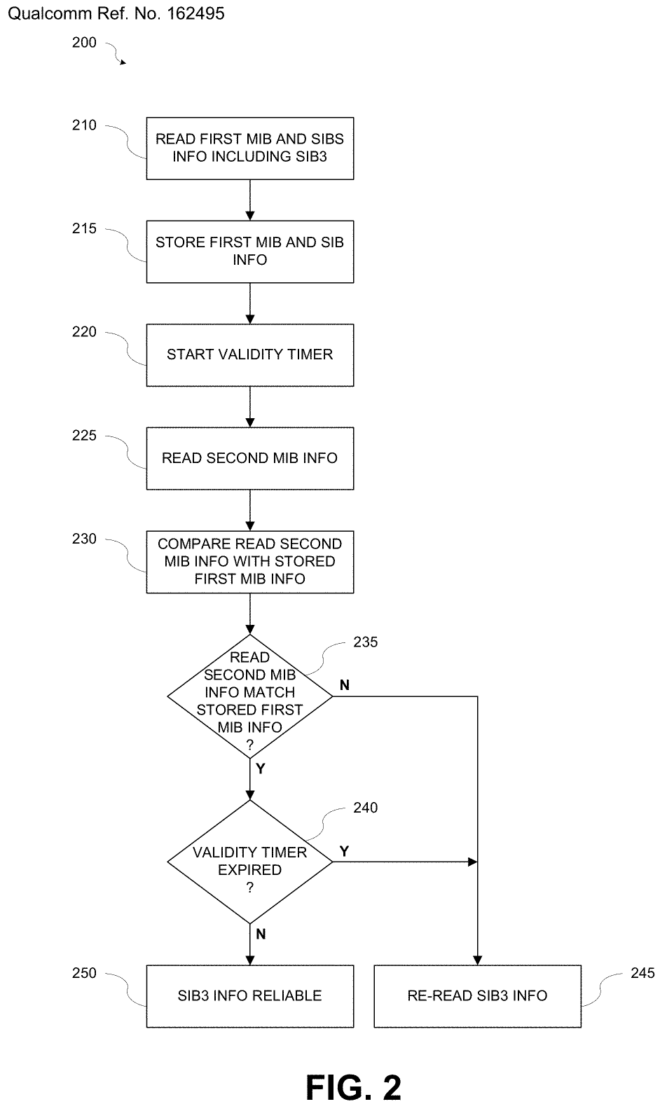

FIG. 2 is a flowchart illustrating a method 200 for reading SIBs according to various examples. Referring to FIG. 2, at block 210 a mobile communication device (e.g., the mobile communication device 100) may read information from a first MIB and one or more SIBs including SIB3. For example, the control unit 110 may control the communication unit 120 to read information from the first MIB and information from one or more SIBs including SIB3. At block 215 the mobile communication device 100 may store the information read from the first MIB (e.g., the MIB value tag, PLMN ID, cell frequency, PSC, and MIB bit string) and the information read from one or more SIBs including SIB3.

At block 220, a validity timer (e.g., the validity timer 114) may be started. For example, the control unit 110 may control the timing unit 112 to start the validity timer 114 after reading and storing information from the first MIB and information from one or more SIBs including SIB3. The duration of the validity timer 114 may be variable. The control unit 110 may control the timing unit 112 to set the duration for the validity timer 114 to be longer when the mobile communication device 100 is not in a high mobility mode than when the mobile communication device 100 is in a high mobility mode.

For example, when the mobile communication device 100 performs five or more serving cell changes using cell selection or reselection within 10 minutes, the mobile communication device 100 may be in high mobility mode and the control unit 110 may control the timing unit 112 to set the duration to about 15 minutes for the validity timer 114. If the mobile communication device 100 is not in a high mobility mode, for example, the mobile communication device 100 makes less than five serving cell changes using cell selection or reselection within 10 minutes or the mobile communication device 100 is substantially stationary, the control unit 110 may control the timing unit 112 to set the duration of for the validity timer 114 to greater than about 15 minutes.

At block 225 the mobile communication device 100 may read information from a second MIB. For example, after the mobile communication device 100 performs an operation (e.g., BPLMN search, cell selection/reselection, OOS scan, etc.) calling for a SIB update, the control unit 110 may control the communication unit 120 to read information from a second MIB.

At block 230, the control unit 110 may compare the information read from the second MIB with the stored information from the first MIB. For example, the control unit 110 may compare the MIB value tag, PLMN ID, cell frequency, PSC, and MIB bit string read from the second MIB with the stored information from the first MIB. At block 235 the control unit 110 may determine whether the information read from the second MIB matches the stored information from the first MIB.

In response to determining that the information read from the second MIB does not match the stored information from the first MIB (235-N), at block 245 the mobile communication device 100 may re-read the SIB information including the SIB3 information. In response to determining that the information read from the second MIB matches the stored information from the first MIB (235-Y), at block 240 the control unit 110 may determine whether the validity timer has expired.

In response to determining that the validity timer has expired (240-Y), at block 245 the mobile communication device 100 may re-read the SIB information including the SIB3 information. In response to determining that the validity timer has not expired (240-N), at block 250 the control unit 110 may determine that the stored SIB information including the SIB3 information is reliable. Accordingly, the mobile communication device 100 may not re-read at least the SIB3 information.

Thus, when the control unit determines that the information read from the second MIB matches the stored information from the first MIB and the validity timer has not expired, the stored SIB information including the SIB3 information is determined to be reliable. Conversely, even if the information read from the second MIB matches the stored information from the first MIB, if the validity timer has expired, the stored SIB information including the SIB3 information is determined to be unreliable and the mobile communication device 100 will re-read the SIB information.

The method 200 may be embodied on a non-transitory computer readable medium, for example, but not limited to, the memory 180 or other non-transitory computer readable medium known to those of skill in the art, having stored therein a program including computer executable instructions for making a processor, computer, or other programmable device execute the operations of the methods.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for reading system information blocks (SIBs) by a mobile communication device, the method comprising:
reading information from a first master information block (MIB);
reading information from one or more SIBs including SIB3;
storing the information read from the first MIB and the one or more SIBs including SIB3;
starting a validity timer;
reading information from a second MIB;
comparing the information read from the second MIB with the stored information from the first MIB;
in response to determining that the information read from the second MIB matches the stored information from the first MIB, determining whether the validity timer has expired; and
in response to determining that the validity timer has not expired, determining that the stored information read from the first MIB and the one or more SIBs including SIB3 is valid.

2. The method of claim 1 further comprising:
in response to determining that the stored information read from the first MIB and the one or more SIBs including SIB3 is valid, skipping reading at least the SIB3.

3. The method of claim 1, further comprising:
in response to determining that the information read from the second MIB does not match the stored information from the first MIB, determining that the stored information read from the first MIB and the one or more SIBs including SIB3 is not valid.

4. The method of claim 1, further comprising:
in response to determining that the validity timer has expired, determining that the stored information read from the first MIB and the one or more SIBs including SIB3 is not valid.

5. The method of claim 1, wherein the comparing the information read from the second MIB with the stored information from the first MIB comprises comparing a MIB value tag, a PLMN identification, a cell frequency, a primary scrambling code (PSC), and a MIB Bit String.

6. The method of claim 5, wherein the determining that the information read from the second MIB matches the stored information from the first MIB comprises determining that the MIB value tag, the PLMN identification, the cell frequency, the PSC, and the MIB Bit String read from the second MIB matches the stored MIB value tag, PLMN identification, cell frequency, PSC, and MIB Bit String for the first MIB.

7. The method of claim 1, wherein a duration of the validity timer is variable based on mobility of the mobile communication device.

8. The method of claim 7, wherein the duration of the validity timer is greater for the mobile communication device not in a high mobility mode than for the mobile communication device in the high mobility mode.

9. A mobile communication device, comprising:
a communication unit configured to communicate with one or more communication networks;
a memory operably connected to the communication unit;
a timing unit configured to implement one or more timers; and
a control unit operably connected to the communication unit, the memory, and the timing unit, the control unit configured to:
control the communication unit to read information from a first master information block (MIB);
control the communication unit to read information from one or more SIBs including SIB3;
control the memory to store the information read from the first MIB and the one or more SIBs including SIB3;
control the timing unit to start a validity timer;
control the communication unit to read information from a second MIB;
compare the information read from the second MIB with the stored information from the first MIB;
in response to determining that the information read from the second MIB matches the stored information from the first MIB, determine whether the validity timer has expired; and
in response to determining that the validity timer has not expired, determine that the stored information read from the first MIB and the one or more SIBs including SIB3 is valid.

10. The mobile communication device of claim 9, wherein the control unit is further configured to:
in response to determining that the stored information read from the first MIB and the one or more SIBs including SIB3 is valid, controlling the communication unit to skip reading at least the SIB3.

11. The mobile communication device of claim 9, wherein the control unit is further configured to:
in response to determining that the information read from the second MIB does not match the stored information from the first MIB, determine that the stored information read from the first MIB and the one or more SIBs including SIB3 is not valid.

12. The mobile communication device of claim 9, wherein the control unit is further configured to:
in response to determining that the validity timer has expired, determine that the stored information read from the first MIB and the one or more SIBs including SIB3 is not valid.

13. The mobile communication device of claim 9, wherein the comparing the information read from the second MIB with the stored information from the first MIB comprises comparing a MIB value tag, a PLMN identification, a cell frequency, a primary scrambling code (PSC), and a MIB Bit String.

14. The mobile communication device of claim 13, wherein the determining that the information read from the second MIB matches the stored information from the first MIB comprises determining that the MIB value tag, the PLMN identification, the cell frequency, the PSC, and the MIB Bit String read from the second MIB matches the stored MIB value tag, PLMN identification, cell frequency, PSC, and MIB Bit String for the first MIB.

15. The mobile communication device of claim 9, wherein the control unit is further configured to control the timing unit to set a duration of the validity timer based on mobility of the mobile communication device.

16. The mobile communication device of claim 15, wherein the control unit controls the timing unit to set the duration of the validity timer greater for the mobile communication device not in a high mobility mode than for the mobile communication device in the high mobility mode.

17. A non-transitory computer readable medium having stored thereon instructions for causing one or more processors of a mobile communication device to perform operations comprising:
reading information from a first master information block (MIB);
reading information from one or more SIBs including SIB3;
storing the information read from the first MIB and the one or more SIBs including SIB3;
starting a validity timer;
reading information from a second MIB;
comparing the information read from the second MIB with the stored information from the first MIB;
in response to determining that the information read from the second MIB matches the stored information from the first MIB, determining whether the validity timer has expired; and
in response to determining that the validity timer has not expired, determining that the stored information read from the first MIB and the one or more SIBs including SIB3 is valid.

18. The non-transitory computer readable medium having stored therein instructions as defined in claim 17, the instructions further including:
in response to determining that the stored information read from the first MIB and the one or more SIBs including SIB3 is valid, skipping reading at least the SIB3.

19. The non-transitory computer readable medium having stored therein instructions as defined in claim 17, the instructions further including:
in response to determining that the information read from the second MIB does not match the stored information from the first MIB, determining that the stored information read from the first MIB and the one or more SIBs including SIB3 is not valid.

20. The non-transitory computer readable medium having stored therein instructions as defined in claim 17, the instructions further including:
in response to determining that the validity timer has expired, determining that the stored information read from the first MIB and the one or more SIBs including SIB3 is not valid.

21. The non-transitory computer readable medium having stored therein instructions as defined in claim 17, wherein the comparing the information read from the second MIB with the stored information from the first MIB comprises comparing a MIB value tag, a PLMN identification, a cell frequency, a primary scrambling code (PSC), and a MIB Bit String.

22. The non-transitory computer readable medium having stored therein instructions as defined in claim 21, wherein the determining that the information read from the second MIB matches the stored information from the first MIB comprises determining that the MIB value tag, the PLMN identification, the cell frequency, the PSC, and the MIB Bit String read from the second MIB matches the stored MIB value tag, PLMN identification, cell frequency, PSC, and MIB Bit String for the first MIB.

23. The non-transitory computer readable medium having stored therein instructions as defined in claim 17, wherein a duration of the validity timer is variable based on mobility of the mobile communication device.

24. The non-transitory computer readable medium having stored therein instructions as defined in claim 23, wherein the duration of the validity timer is greater for the mobile communication device not in a high mobility mode than for the mobile communication device in the high mobility mode.

25. A mobile communication device, comprising:
means for reading information from a first master information block (MIB);
means for reading information from one or more SIBs including SIB3;
means for storing the information read from the first MIB and the one or more SIBs including SIB3;
means for starting a validity timer;
means for reading information from a second MIB;
means for comparing the information read from the second MIB with the stored information from the first MIB;
in response to determining that the information read from the second MIB matches the stored information from the first MIB, means for determining whether the validity timer has expired; and
in response to determining that the validity timer has not expired, means for determining that the stored information read from the first MIB and the one or more SIBs including SIB3 is valid.

26. The mobile communication device of claim 25, further comprising:
in response to determining that the stored information read from the first MIB and the one or more SIBs including SIB3 is valid, means for skipping reading at least the SIB3.

27. The mobile communication device of claim 25, further comprising:
in response to determining that the information read from the second MIB does not match the stored information from the first MIB, means for determining that the stored information read from the first MIB and the one or more SIBs including SIB3 is not valid.

28. The mobile communication device of claim 25, further comprising:
in response to determining that the validity timer has expired, means for determining that the stored information read from the first MIB and the one or more SIBs including SIB3 is not valid.

29. The mobile communication device of claim 25, wherein a duration of the validity timer is variable based on mobility of the mobile communication device.

30. The mobile communication device of claim 29, wherein the duration of the validity timer is greater for the mobile communication device not in a high mobility mode than for the mobile communication device in the high mobility mode.
